(19) United States
(12) Patent Application Publication
(10) Pub. No.: US 2005/0057577 A1
(43) Pub. Date: Mar. 17, 2005

(54) Method and apparatus for generating image data

(75) Inventor: Takao Kuwabara, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/927,108

(22) Filed: Aug. 27, 2004

(30) Foreign Application Priority Data
Aug. 29, 2003 (JP) 306797/2003

(51) Int. Cl. G09G 5/00

(52) U.S. Cl. 345/629

(57) ABSTRACT

Decreases in image quality that occur, when a plurality of image data groups that represent a plurality of image portions that have a shared region are synthesized to generate an image data set that represents a single composite image, are suppressed. First and second image data groups, which respectively represent two image portions that have a shared region, are prepared. Correction processes are uniformly administered on pixel data within the first image data group so that a representative value of the pixel data within the shared region thereof match a representative value of the shared region of the second image data group. Then, an image data set that represents the composite image is generated by synthesizing the corrected first image data group and the second image data group.

### BACKGROUND OF THE INVENTION

1. Field of the Invention

The present invention relates to a method and an apparatus for generating image data. More particularly, the present invention relates to a method and an apparatus for generating a composite image data set that represents a single image, by synthesizing a plurality of image data groups that represent image portions which have shared regions therein.

2. Description of the Related Art

There are known apparatuses that read out originals. These apparatuses comprise linear detecting portions, comprising line sensors that have a great number of light receiving portions, and are arranged in a main scanning direction. The originals are read out by moving the linear detecting portions over the originals in a sub scanning direction. To read out large originals with this type of apparatus, wide linear detecting portions equipped with long line sensors are utilized. However, it is difficult to manufacture long seamless line sensors. Therefore, linear detecting portions that function as a single long line sensor, in which a plurality of line sensors are arranged in the main scanning direction so that the edges of the detection ranges thereof overlap, are employed.

In the case that large originals are read out by linear detecting portions that are constructed in this manner, the light receiving portions positioned at the edges of each line sensor detect light emitted from the same positions of the large original in a duplicate manner. Each line sensor obtains image data (also referred to as image data groups) that represents the shared image portion, that is, the same positions of the large original. The image data groups are synthesized, to generate an image data set that represents the entirety of the large original.

As a technique for generating the image data set that represents the entirety of the large original by synthesizing the image data groups there is known that which is disclosed in Japanese Unexamined Patent Publication No. 2002-57860 and in U.S. Pat. No. 6,348,981. This technique administers a weighted averaging process on the image data of the shared image portions, obtained by light receiving portions positioned at the ends of each line sensor. The image data are weighted less as the light receiving portion that obtained it is closer to the end of the line sensor. Weighted and averaged image data are obtained for each position, and the image data set that represents the entirety of the large original is generated by employing the weighted and averaged image data.

However, there are cases in which each of the line sensors that constitute the linear detecting means have different sensitivities from each other. In these cases, the image data groups, which are obtained by each line sensor, have specific properties due to the different sensitivities. Therefore, even if the above weighted averaging process is administered on the connection portions of the image data groups so that band-like regions that extend in the sub scanning direction do not stand out, no processes are administered on image data that represents other regions. Therefore, the specific properties appear in the image data that represents the other regions, resulting in different qualities of images for each of the other regions. Accordingly, there is a possibility that the image quality of the image that represents the entirety of the large original is decreased.

### SUMMARY OF THE INVENTION

The present invention has been developed in view of the above circumstances. It is an object of the present invention to provide a method and apparatus for generating image data that suppresses decrease in quality of an image data set, which is generated by synthesizing image data groups that represent a plurality of image portions that have shared regions therein.

The method for generating image data of the present invention is a method for generating a composite image data set from a plurality of image data groups that represent image portions which have shared regions therein, comprising the steps of:
uniformly administering correction processes on pixel data within at least one predetermined image data group so that the representative values of the pixel data within the shared regions thereof match representative values of the shared region of another image data group; and
generating the composite image data set by utilizing the at least one predetermined image data group, which has undergone the correction processes.

The apparatus for generating image data of the present invention is an apparatus for generating a composite image data set, comprising:
an image synthesizing means, for synthesizing the composite image data set from a plurality of image data groups that represent image portions which have shared regions therein;
a representative value calculating means, for obtaining representative values of pixel data within the shared regions of image data sets within each image data group; and
a correcting means, for uniformly correcting the pixel data within at least one predetermined image data group so that the representative values of the pixel data within the shared regions thereof match the representative values of the shared region of image data sets in another image data group; wherein:
the image synthesizing means generates an image data set that represents the composite image utilizing the at least one predetermined image data group, which has been corrected.

Here, “uniformly correcting the pixel data within at least one predetermined image data group” refers to administering processes based on the same correction rules on the pixel data, regardless of their positions. The correction rule may be, for example, that which changes the content of correction calculations with respect to each pixel datum, according to the value thereof.

The representative values may be determined based on mean values, median values, or histograms of each of the pixel data within the shared region of the image data groups.

The correction may be a process in which each of the pixel data of the at least one predetermined image data group are multiplied by the ratios of representative values of the other image data group with respect to the representative values of the at least one predetermined image data group. Alternatively, the correction may be a process in which differences between the representative values of the other image data group and the representative values of the at least one predetermined image data group are added to each of the pixel data of the at least one predetermined image data group. As a further alternative, the correction may be a process in which each of the pixel data of the at least one predetermined image data group are multiplied by the ratios of representative values of the other image data group with respect to the representative values of the at least one predetermined image data group, in the case that the values of the pixel data of the at least one predetermined image data group are less than the representative value of the at least one predetermined image data group; and
the correction is a process in which differences between the representative values of the other image data group and the representative values of the at least one predetermined image data group are added to each of the pixel data of the at least one predetermined image data group, in the case that the pixel data of the at least one predetermined image data group are greater than or equal to the representative value of the at east one predetermined image data group.

The apparatus of the present invention may further comprise:
a line detecting means constituted by a plurality of line sensors, which are arranged so that the longitudinal directions of each of the line sensors overlap in a main scanning direction; wherein:
an image carrier is relatively moved with respect to the line detecting means in a sub scanning direction that intersects with the main scanning direction, so that light emitted from the image carrier is detected by the line detecting means to obtain image data that represents image information carried by the image carrier, while photoreceptors positioned at the overlapping ends of the line sensors detect light emitted from common regions of the image carrier in a duplicate manner; and
the image data groups comprise image data obtained by each of the plurality of line sensors.

The image data groups may comprise image data that represents image information of linear regions that extend in the main scanning direction of the image carrier. Alternatively, the image data groups may comprise image data that represents image information of a single row of pixel regions that extend in the main scanning direction of the image carrier. Note that the image data borne by a single pixel region corresponds to image data represented by a single pixel datum.

According to the method and apparatus for generating image data of the present invention, correction processes are uniformly administered on pixel data within at least one predetermined image data group so that the representative values of the pixel data within the shared regions thereof match representative values of the shared region of another image data group. Then, a composite image data set is generated by utilizing the at least one predetermined image data group, which has undergone the correction processes. Thereby, correction of the pixel data is performed so that the differences among specific properties of main components of each image data group are reduced. Therefore, differences in the qualities of images, which are represented by each of the image data groups, are also reduced. Accordingly, a decrease in image quality, which occurs when an image data set that represents a single image is generated by synthesizing the image data groups, is enabled to be suppressed.

The representative values may be determined based on mean values, median values, or histograms of each of the pixel data within the shared region of the image data groups. In this case, the representative values may be obtained easily.

The correction may be a process in which each of the pixel data of the at least one predetermined image data group are multiplied by the ratios of representative values of the other image data group with respect to the representative values of the at least one predetermined image data group. Alternatively, the correction may be a process in which differences between the representative values of the other image data group and the representative values of the at least one predetermined image data group are added to each of the pixel data of the at least one predetermined image data group. As a further alternative, the correction may be a process in which each of the pixel data of the at least one predetermined image data group are multiplied by the ratios of representative values of the other image data group with respect to the representative values of the at least one predetermined image data group, in the case that the values of the pixel data of the at least one predetermined image data group are less than the representative value of the at least one predetermined image data group; and the correction is a process in which differences between the representative values of the other image data group and the representative values of the at least one predetermined image data group are added to each of the pixel data of the at least one predetermined image data group, in the case that the pixel data of the at least one predetermined image data group are greater than or equal to the representative value of the at east one predetermined image data group. By adopting these processes, the correction can be positively effected.

The apparatus of the present invention may further comprise:
a line detecting means constituted by a plurality of line sensors, which are arranged so that the longitudinal directions of each of the line sensors overlap in a main scanning direction; wherein:
an image carrier is relatively moved with respect to the line detecting means in a sub scanning direction that intersects with the main scanning direction, so that light emitted from the image carrier is detected by the line detecting means to obtain image data that represents image information carried by the image carrier, while photoreceptors positioned at the overlapping ends of the line sensors detect light emitted from common regions of the image carrier in a duplicate manner; and
the image data groups comprise image data obtained by each of the plurality of line sensors. In the case that this configuration is adopted, the shared regions, and the regions represented by each image data group become band-like regions that extend in the sub scanning direction of the image carrier. Differences in quality among the image data groups, due to the specific properties thereof, appear more clearly in this configuration. Therefore, the decrease in image quality, which occurs when an image data set that represents a single image is generated by synthesizing the image data groups, is enabled to be more conspicuously suppressed, by administering the correction processes.

The image data groups may comprise image data that represents image information of linear regions that extend in the main scanning direction of the image carrier. Alternatively, the image data groups may comprise image data that represents image information of a single row of pixel regions that extend in the main scanning direction of the image carrier. In these cases, the correction processes can be administered on small regions of the image carried by the image carrier. Therefore, the decrease in image quality, which occurs when an image data set that represents a single image is generated by synthesizing the image data groups, is enabled to be more positively suppressed.

### BRIEF DESCRIPTION OF THE DRAWINGS

FIG. 1 is a block diagram that illustrates the schematic structure of an image data generating apparatus according to an embodiment of the present invention.

FIG. 2 illustrates the manner in which image data groups that represent a plurality of image portions having a shared region are synthesized to generate a single composite image.

FIG. 3 illustrates a case in which each of three partitioned regions of an entire image comprise a plurality of image portions that have a shared region.

FIG. 4A to 4F illustrate a case in which an image data set that represents a single composite image is generated by synthesizing five image data groups, each of which represents an image portion.

FIG. 5 is a histogram that indicates the pixel data values of an image data group.

FIG. 6 is a perspective view that illustrates the schematic structure of an image readout apparatus, equipped with an image data generating apparatus.

### BEST MODE FOR CARRYING OUT THE INVENTION

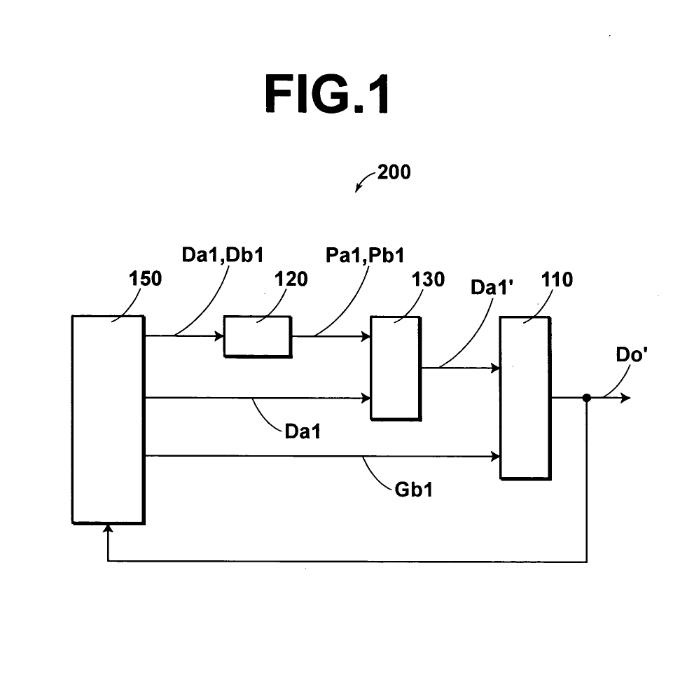

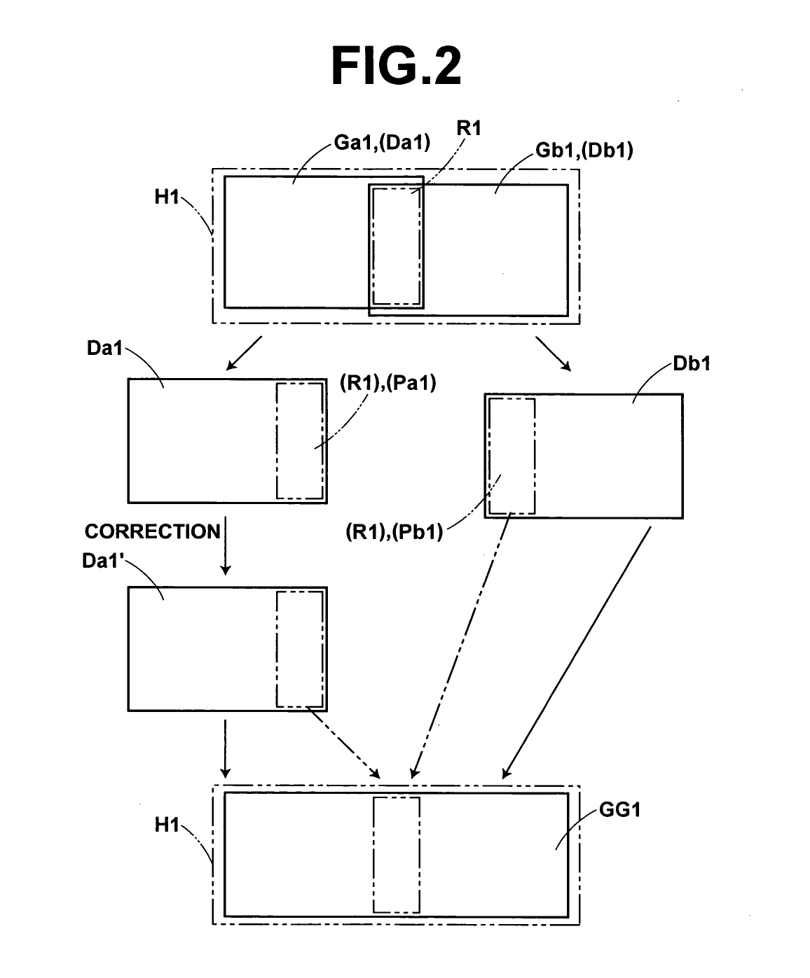

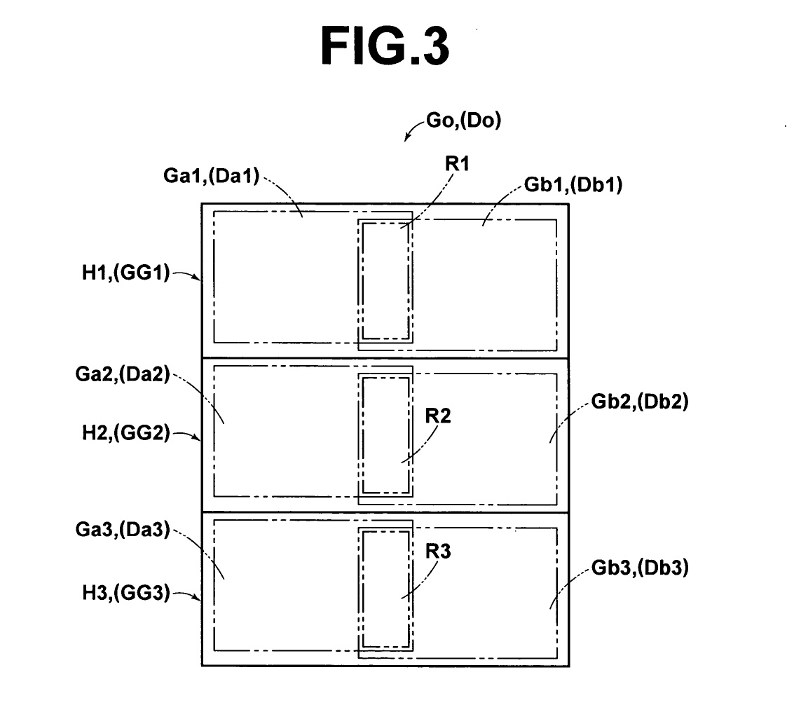

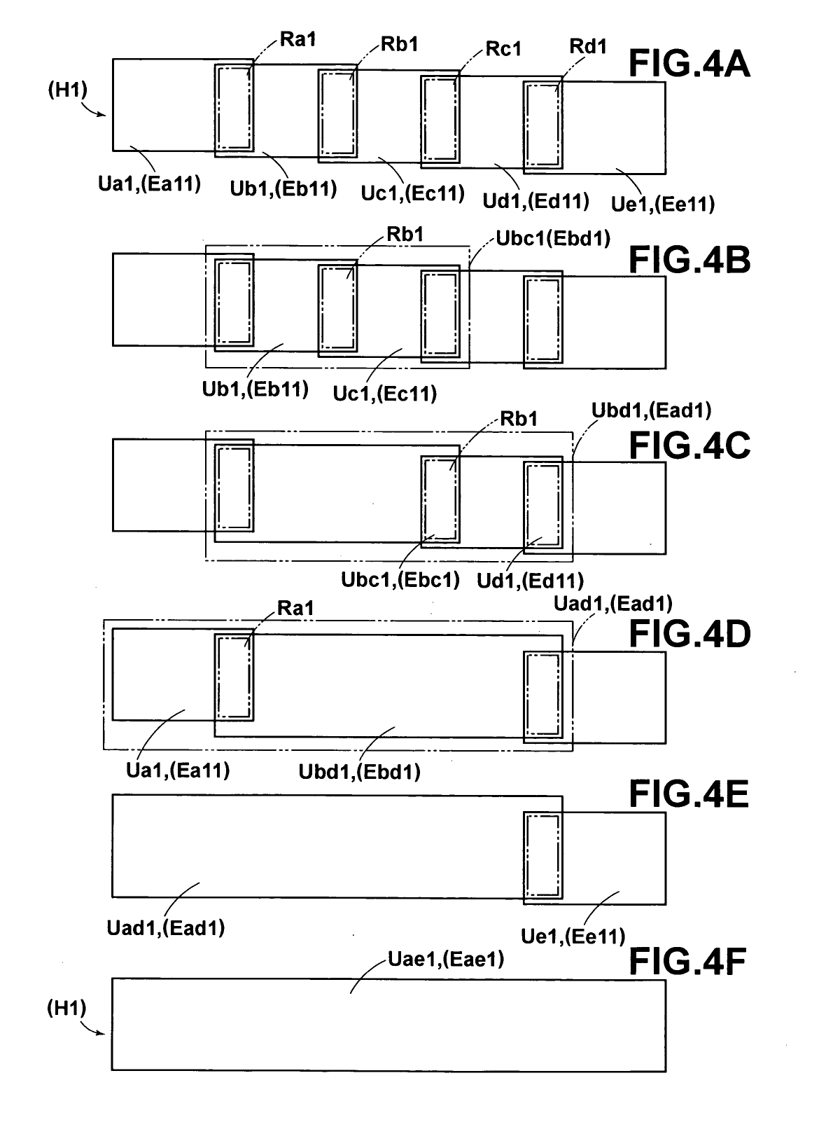

Hereinafter, an embodiment of the present invention will be described with reference to the attached drawings. FIG. 1 is a block diagram that illustrates the schematic structure of an image data generating apparatus according to the embodiment of the present invention. FIG. 2 illustrates the manner in which image data groups that represent a plurality of image portions having a shared region are synthesized to generate a single composite image. FIG. 3 illustrates a case in which each of three partitioned regions of an entire image comprise a plurality of image portions that have a shared region. FIG. 4A to 4F illustrate a case in which an image data set that represents a single composite image is generated by synthesizing five image data groups, each of which represents an image portion.

An image data generating apparatus 200 illustrated in FIG. 1 comprises: an image memory 150; a representative value calculating means 120; a correcting means 130; and an image data synthesizing means 110. The image memory 150 has recorded therein image data groups Da1 and Db1 that represent image portions Ga1 and Gb1, which have a shared region R1, respectively. The representative value calculating means 120 obtains representative values Pa1 and Pa2, of the pixel data within the shared region R1 in the image data groups Da1 and Db1, respectively. The correcting means 130 uniformly corrects all of the pixel data within the image data group Da1, so that the representative value Pa1 of the pixel data that represent the shared region R1 thereof matches the representative value Pb1 of the pixel data that represent the shared region R1 of the image data group Db1. The image data synthesizing means 110 utilizes the pixel data of an image data group Da1′, which is the image data group Da1 after correction, and the pixel data of the image data group Db1 to generate an image data set that represents a single composite image GG1.

The representative value calculating means 120 determines the representative values of the pixel data within the shared region R1 of the image data groups Da1 and Db2. The representative value is, for example, a value that appears most frequently, as determined based on a mean value, a median value, or a histogram of the pixel data.

Note that the image memory 150 has recorded therein an image data set Do that represents an entire image Go, which includes the image portions Ga1 and Gb1. As illustrated in FIG. 3, the entire image Go comprises horizontal regions H1, H2, and H3 that extend in the horizontal direction (also referred to as “a main scanning direction”), which result when the entire image Go is partitioned in the vertical direction (also referred to as “a sub scanning direction”) into these three regions. The horizontal region H1 comprises the plurality of image portions Ga1 and Gb1, which have the shared region R1. The horizontal region H2 comprises a plurality of image portions Ga2 and Gb2, which have a shared region R2. The horizontal region H3 comprises a plurality of image portions Ga3 and Gb3, which have a shared region R3. The image data set Do, which is recorded in the image memory 150, comprises the image data groups Da1 and Db1, which respectively represent the image portions Ga1 and Ga2, image data groups Da2 and Db2, which respectively represent the image portions Ga2 and Gb2, and image data groups Da3 and Db3, which respectively represent the image portions Ga3 and Gb3.

Hereinafter, the image data set generation process, which is performed by the image data generating apparatus 200, will be described.

First, the image data groups Da1 and Db1, which represent the horizontal region H1, is input from the image memory 150 to the representative value calculating means 120. The representative value calculating means 120 obtains a mean value of all of the pixel data within the shared region R1 of the image data group Da1, and designates it as the representative value Pa1. The representative value calculating means 120 obtains a mean value of all of the pixel data within the shared region R1 of the image data group Db1, and designates it as the representative value Pb1.

Next, the image data group Da1 is input to the correcting means 130, which uniformly corrects all of the pixel data of the image data group Da1 so that the representative value Pa1 of the corrected pixel data matches the representative value Pb1. That is, the same process is administered on each pixel data (Xi, Yj) of the image data group Da1 regardless of the position of the image that it represents. More specifically, each of the pixel data of the image data group Da1 is multiplied by the ratio of the representative value Pb1 of the image data group Db1 with respect to the representative value Pa1 of the image data group Da1, for example, to obtain the corrected image data group Da1′. The corrected pixel data Da1′ (Xi, Yj) of the corrected image data group Da1′ are calculated by the formula:
Da1′(Xi, Yj)=Da1(Xi, Yj)×(Pb1/Pa1)

Thereafter, the image data synthesizing means 110 generates an image data set that represents a single composite image GG1, utilizing the pixel data Da1′ (Xi, Yj) of the corrected image data group Da1′, which is obtained by correcting the image data group Da1, and the pixel data Db1(Xi, Yj) of the image data group Db1.

More specifically, the pixel data Da1′ (Xi, Yj) are employed as pixel data that represent regions of the image portion Ga1 other than the shared region R1. Likewise, the pixel data Db1 (Xi, Yj) are employed as pixel data that represent regions of the image portion Gb1 other than the shared region R1. As pixel data Dr1 that represent the shared region R1, average values of the pixel data Da1′ (Xi, Yj) and the pixel data Db1 (Xi, Yj) are employed. That is, the pixel data Dr1 obtained by employing the average values are calculated by the formula:
Dr1(Xi, Yj)={Da1′(Xi, Yj)+Db1(Xi, Yj)}/2.
Thereby, an image data set that represents the single composite image GG1, which corresponds to the horizontal region H1, is generated. The image data set that represents the single composite image GG1 is recorded in the image data synthesizing means 110.

The same processes as above are administered to the image data groups Da2 and Db2, which represent the horizontal region H2, and an image data set that represents a single composite image GG2, which corresponds to the horizontal region H2, is generated. The same processes as above are also administered to the image data groups Da3 and Db3, which represent the horizontal region H3, and an image data set that represents a single composite image GG3, which corresponds to the horizontal region H3, is generated. The image data sets that represent the composite images GG2 and GG3 are also recorded in the image data synthesizing means 110.

The image data sets that represent the composite images GG1, GG2, and GG3 are further synthesized by the image data synthesizing means 110, to generate an image data set Do′, which represents the entire image Go.

Here, an alternate case in which an image data set that represents a single composite image that corresponds to the horizontal region H1 is generated will be described. In this case, the horizontal region H1 comprises five image portions that have shared regions, as illustrated in FIG. 4A. Note that the image portions that constitute the horizontal region H1 are designated as image portions Ua1, Ub1, Uc1, Ud1, and Ue1. The image portions Ua1 and Ub1 have a shared region Ra1, the image portions Ub1 and Uc1 have a shared region Rb1, the image portions Uc1 and Ud1 have a shared region Rc1, and the image portions Ud1 and Ue1 have a shared region Rd1. The image data groups that respectively represent the image portions Ua1, Ub1, Uc1, Ud1, and Ue1 are designated as image data groups Ea11, Eb11, Ec11, Ed11, and Ee11, respectively.

First, the image data group, which is to serve as a reference image data group, is determined. In this case, the image data group Ec11, which represents the image portion Uc1, is designated as the reference image data group in generating the image data set that represents the composite image. The shared region Rb1 is designated as a shared region of interest. The image data groups Eb11 and Ec11, which respectively represent the image portions Ub1 and Uc1 that have the shared region Rb1, are read out from the image memory 150, as illustrated in FIG. 4B. These image data groups are synthesized according to the same technique as that described above, and an image data group Ebc1, which represents a single composite image Ubc1, is generated. Thereafter, the generated image data group Ebc1 is recorded in the image memory 150.

Note that the image data group Ebc1 comprises an image data group Eb12, which is the predetermined image data group Eb11 after each of the pixel data therein has been uniformly corrected, and the image data group Ec11. The pixel data that represents the region Rb1, which is shared by the image data groups Eb12 and Ec11 within the image data group Ebc1, are also processed according to the same technique as that described above.

Next, the region Rc1 is designated as the shared region of interest. The image data groups Ed11 and Ebc11, which respectively represent the image portions Ud1 and Ubc1 that have the shared region Rc1, are read out from the image memory 150, as illustrated in FIG. 4C. These image data groups are synthesized according to the same technique as that described above, and an image data group Ebd1, which represents a single composite image Ubd1, is generated. Thereafter, the generated image data group Ebd1 is recorded in the image memory 150.

Note that the image data group Ebd1 comprises an image data group Ed12, which is the predetermined image data group Ed11 after each of the pixel data therein has been uniformly corrected, and the image data group Ebc11. The pixel data that represents the region Rc1, which is shared by the image data groups Ed12 and Ebc11 within the image data group Ebd1, are also processed according to the same technique as that described above.

Continuing, the region Ra1 is designated as the shared region of interest. The image data groups Ea11 and Ebd11, which respectively represent the image portions Ua1 and Ubd1 that have the shared region Ra1, are read out from the image memory 150, as illustrated in FIG. 4D. These image data groups are synthesized according to the same technique as that described above, and an image data group Ead1, which represents a single composite image Uad1, is generated. Thereafter, the generated image data group Ead1 is recorded in the image memory 150.

Note that the image data group Ead1 comprises an image data group Ea12, which is the predetermined image data group Ea11 after each of the pixel data therein has been uniformly corrected, and the image data group Ebd11. The pixel data that represents the region Ra1, which is shared by the image data groups Ea12 and Ebd11 within the image data group Ead1 is also processed according to the same technique as that described above.

Finally, the region Rd1 is designated as the shared region of interest. The image data groups Ee11 and Ead11, which respectively represent the image portions Ue1 and Uad1 that have the shared region Rd1, are read out from the image memory 150, as illustrated in FIG. 4E. These image data groups are synthesized according to the same technique as that described above, and an image data group Eae1 is generated. The image data group Eae1 is an image data set that represents the single composite image corresponding to the horizontal region H1. Note that the values of the pixel data that represent the image portion Uc1, excluding the portions that represent the shared regions Rb1 and Rc1, remain unchanged by the above processes.

Note that the correction performed by the correcting means 130 is not limited to the process in which each of the pixel data of a predetermined image data group are multiplied by the ratios of representative values of another image data group with respect to the representative values of the predetermined image data group (also referred to as “correction ratio coefficient”). Alternatively, the correction may be a process in which differences between the representative values of the other image data group and the representative values of the predetermined image data group (also referred to as “correction addition coefficient”) are added to each of the pixel data of the predetermined image data group.

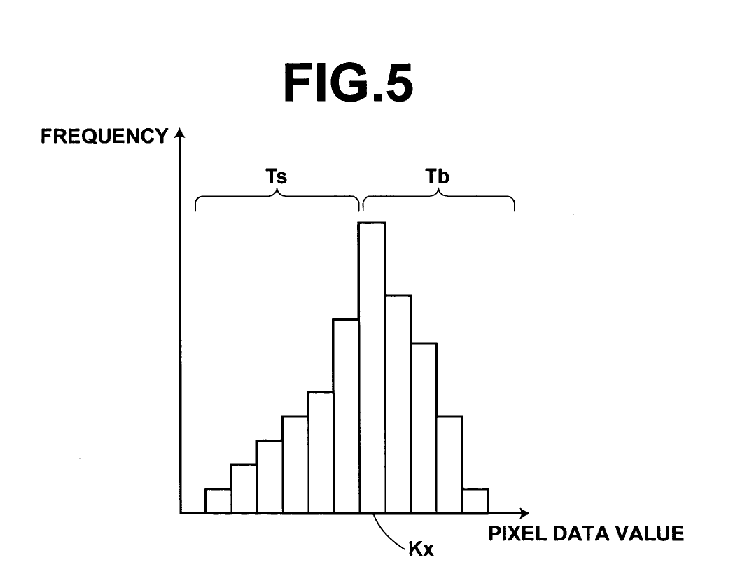

Further, the correction performed by the correcting means 130 may be a process in which each of the pixel data of the predetermined image data group subject to correction are multiplied by the ratios of representative values of the other image data group with respect to the representative values of the predetermined image data group (correction ratio coefficient), in the case that the values of the pixel data of the predetermined image data group are less than the representative value of the predetermined image data group; and
a process in which differences between the representative values of the other image data group and the representative values of the predetermined image data group (correction addition coefficient) are added to each of the pixel data of the predetermined image data group subject to correction, in the case that the pixel data of the predetermined image data group are greater than or equal to the representative value of the predetermined image data group. This correction rule is applied uniformly, regardless of the position represented by the pixel data. For example, the representative value of pixel data that represents a shared region within a predetermined image data group may be determined based on a histogram that represents the pixel data values of the image data group. In the case that a value Kx, which appears most frequently as a pixel data value in the histogram of FIG. 5, is designated as the representative value, the aforementioned correction by multiplication (correction using the correction ratio coefficient) is administered on pixel data having values less than Kx (indicated by Ts in FIG. 5). Meanwhile, the aforementioned correction by addition (correction using the correction addition coefficient) is administered on pixel data having values greater than or equal to Kx (indicated by Tb in FIG. 5). Thereby, pixel data having comparatively low or comparatively high values are prevented from being corrected to become extremely large with respect to the original pixel data. In addition, pixel data having values greater than or equal to a threshold value may be uncorrected, in order to prevent pixel data having comparatively large values from being corrected to have even larger values.

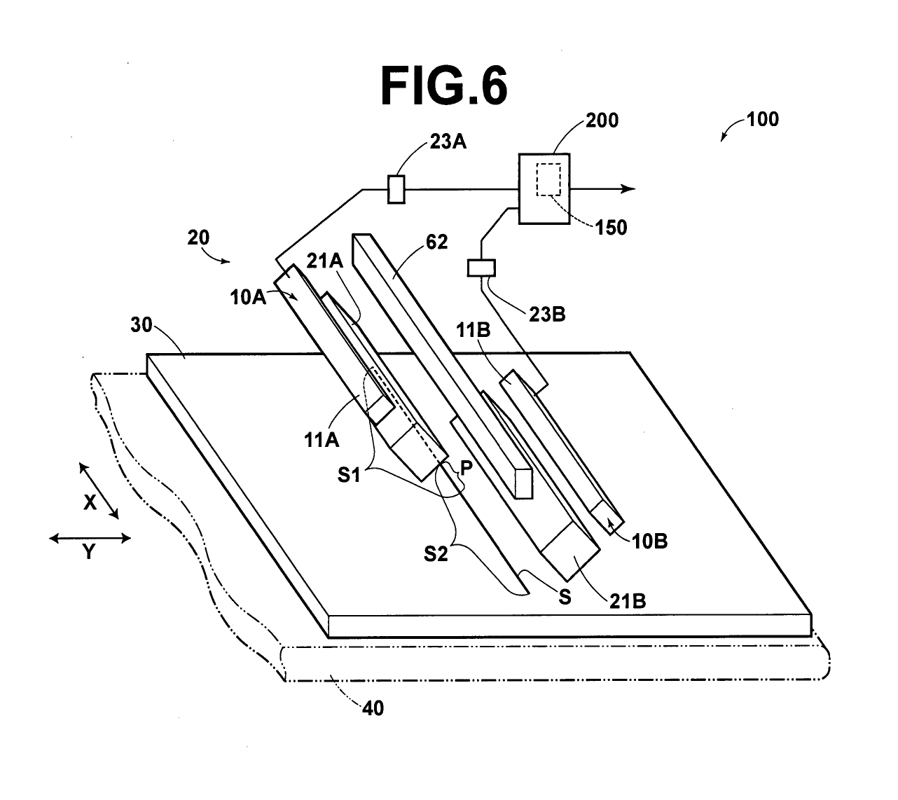

Hereinafter, a case will be described wherein:
the image data generating apparatus further comprises a line detecting means constituted by a plurality of line sensors, which are arranged so that the longitudinal directions of each of the line sensors overlap in a main scanning direction;
an image carrier is relatively moved with respect to the line detecting means in a sub scanning direction, which is perpendicular to the main scanning direction, so that light emitted from the image carrier is detected by the line detecting means to obtain image data that represents image information carried by the image carrier, while photoreceptors positioned at the overlapping ends of the line sensors detect light emitted from common regions of the image carrier in a duplicate manner; and
the image data groups comprise image data that represents image information of linear regions that extend in the main scanning direction of the image carrier, which is obtained by each of the plurality of line sensors. More specifically, a case will be described wherein the image data groups comprise image data that represents image information of a single row of pixel regions (also referred to a “single linear region”) that extend in the main scanning direction of the image carrier. Note that the image information borne by the single pixel region corresponds to image information represented by a single pixel datum. The image data are read out by an image readout apparatus, which will be described later. The image readout apparatus is equipped with the image data generating apparatus. The image readout apparatus reads out the image information borne by the image carrier to obtain the image data groups, and synthesizes the image data groups to generate an image data set that represents a single composite image. FIG. 6 is a perspective view that illustrates the schematic structure of an image readout apparatus 100, equipped with an image data generating apparatus.

As illustrated in FIG. 6, the image readout apparatus 100 comprises: a linear detecting portion 20; a sub scanning portion 40; and an image data generating portion 200. The linear detecting portion 20 comprises a plurality of line sensors 10A and 10B, each of which has a great number of linearly arranged photoreceptors. The line sensors 10A and 10B are arranged so that their longitudinal directions are aligned with a main scanning direction (indicated by arrow X in FIG. 6, hereinafter referred to as “main scanning direction X”). The line sensors 10A and 10B are also arranged so that photoreceptors positioned at the overlapping ends 11A and 11B thereof detect light emitted from the same positions of an image carrier in a duplicate manner. The sub scanning portion 40 moves an original 30, which is the image carrier, in a sub scanning direction (indicated by arrow Y in FIG. 6, hereinafter referred to as “sub scanning direction Y”), which is perpendicular to the main scanning direction X. The image data generating portion 200 is the aforementioned image data generating apparatus. The image data generating portion 200 generates an image data set that represents a single composite image corresponding to the entirety of the image information borne by the original 30. The image data set is generated based on image data, which is obtained by detecting light that is emitted by the original 30 during movement thereof in the sub scanning direction Y. Note that the line sensors 10A and 10B are a portion of a plurality of line sensors, which are arranged in a staggered manner. Other line sensors have the same structure and operation as the line sensors 10A and 10B. However, only the structure and operation of the line sensors 10A and 10B will be described, to facilitate the description.

The linear detecting portion 20 further comprises focusing lenses 21A and 21B and A/D converters 23A and 23B, in addition to the line sensors 10A and 10B. The focusing lenses 21A and 21B extend in the main scanning direction X, and comprise gradient index lenses or the like. The focusing lenses 21A and 21B focus images of linear regions S, which extend in the main scanning direction X, of the original 30 onto the photoreceptors of the line sensors 10A and 10B. The A/D converters 23A and 23B convert electric signals detected by the photoreceptors by receiving light, which is propagated via the focusing lenses 21A and 21B, into pixel data having digital values. The focusing lens 21A focuses an image of a region S1, which is a portion of the linear region S, onto the photoreceptors of the line sensor 10A. The focusing lens 21B focuses an image of a region S2, which is a portion of the linear region S and a portion of which overlaps with the region S1, onto the photoreceptors of the line sensor 10B.

The original 30 is illuminated by a linear light source 62. The linear light source 62 comprises a great number of LD light sources and toric lenses for condensing the light emitted from the LD light sources onto the linear region S. The light emitted from the linear light source 62 is reflected at the linear regions S1 and S2, which extend in the main scanning direction X, of the original 30, then focused on the photoreceptors of the line sensors 10A and 10B, respectively.

Next, a case in which the image readout apparatus 100 obtains image data will be described.

The original 30 is illuminated by the linear light source 62 while it is being moved in the sub scanning direction Y by the sub scanning portion 40. The light emitted from the linear light source 62 and reflected by the original 30 is focused on the photoreceptors of the line sensors 10A and 10B via the focusing lenses 21A and 21B. Regarding the overlapping photoreceptors, light reflected by a region P, which is included in both the regions S1 and S2, are respectively focused on the photoreceptors of the line sensor 10A at its end 11A and on the photoreceptors of the line sensor 10B at its end 11B by the focusing lenses 21A and 21B.

The electric signals detected by the photoreceptors of the line sensor 10A are converted into digital signals by the A/D converter 23A, which inputs the digital signals into the image data generating portion 200 as image data group A. Likewise, the electric signals detected by the photoreceptors of the line sensor 10B are converted into digital signals by the A/D converter 23B, which inputs the digital signals into the image data generating portion 200 as image data group B.

The image data groups A and B, which are input to the image data generating portion 200, are recorded in the image memory 150 of the image data generating portion 200. The image data groups A and B comprise pixel data that represent linear image portions corresponding to the single linear region of the original 30 that have a shared region (region P). The image data generating portion 200 reads out the image data groups A and B from the image memory 150 and generates an image data set that represents a single composite image corresponding to each single linear region by the same technique as that described previously. Then, each of the composite images corresponding to the single linear regions are synthesized in the sub scanning direction Y, to generate an image data set that represents the entirety of the original 30.

Note that the composite images for each single linear region are generated by the technique described previously, employing the correction ratio coefficient or the correction addition coefficient (hereinafter, collectively referred to as “correction coefficients”), then the composite images for each single linear region are synthesized in the sub scanning direction. In this case, variance among the pixel data values may become excessive in the sub scanning direction. Therefore, it is desirable to obtain moving averages of the correction coefficients, which were obtained for each single linear region, in the sub scanning direction, which is the direction that the composite images of the linear regions are synthesized. Thereby, high frequency components related to the variance in the values of the correction coefficients are reduced. Accordingly, correction coefficients, in which variance in short period components of the original correction coefficients in the sub scanning direction are reduced, are obtained. These correction coefficients are utilized to correct the image data sets that represent each single linear region, then the image data set that represents the single composite image is generated.

Note that in the embodiment described above, cases in which two image data groups that represent two image portions that have a shared region are synthesized to generate an image data set that represents a single composite image have been described. However, the technique described above may be applied to a case in which three or more image data groups that represent three or more image portions that have a shared region are synthesized to generate an image data set that represents a single composite image. In this case, correction processes are uniformly administered on pixel data within at least two predetermined image data groups so that the representative values of the pixel data within the shared regions thereof match representative values of the shared region of another image data group. Then, the composite image data set may be generated by utilizing the at least two predetermined image data groups, which have undergone the correction processes.

1. A method for generating a composite image data set from a plurality of image data groups that represent image portions which have shared regions therein, comprising the steps of:
uniformly administering correction processes on pixel data within at least one predetermined image data group so that the representative values of the pixel data within the shared regions thereof match representative values of the shared region of another image data group; and
generating the composite image data set by utilizing the at least one predetermined image data group, which has undergone the correction processes.

2. An apparatus for generating a composite image data set, comprising:
an image synthesizing means, for synthesizing the composite image data set from a plurality of image data groups that represent image portions which have shared regions therein;
a representative value calculating means, for obtaining representative values of pixel data within the shared regions of image data sets within each image data group; and
a correcting means, for uniformly correcting the pixel data within at least one predetermined image data group so that the representative values of the pixel data within the shared regions thereof match the representative values of the shared region of image data sets in another image data group; wherein:
the image synthesizing means generates an image data set that represents the composite image utilizing the at least one predetermined image data group, which has been corrected.

3. An apparatus for generating a composite image data set as defined in claim 2, wherein:
the representative values are determined based on mean values, median values, or histograms of each of the pixel data within the shared region of the image data groups.

4. An apparatus for generating a composite image data set as defined in claim 2, wherein:
the correction is a process in which each of the pixel data of the at least one predetermined image data group are multiplied by the ratios of representative values of the other image data group with respect to the representative values of the at least one predetermined image data group.

5. An apparatus for generating a composite image data set as defined in claim 3, wherein:
the correction is a process in which each of the pixel data of the at least one predetermined image data group are multiplied by the ratios of representative values of the other image data group with respect to the representative values of the at least one predetermined image data group.

6. An apparatus for generating a composite image data set as defined in claim 2, wherein:
the correction is a process in which differences between the representative values of the other image data group and the representative values of the at least one predetermined image data group are added to each of the pixel data of the at least one predetermined image data group.

7. An apparatus for generating a composite image data set as defined in claim 3, wherein:
the correction is a process in which differences between the representative values of the other image data group and the representative values of the at least one predetermined image data group are added to each of the pixel data of the at least one predetermined image data group.

8. An apparatus for generating a composite image data set as defined in claim 2, wherein:
the correction is a process in which each of the pixel data of the at least one predetermined image data group are multiplied by the ratios of representative values of the other image data group with respect to the representative values of the at least one predetermined image data group, in the case that the values of the pixel data of the at least one predetermined image data group are less than the representative value of the at least one predetermined image data group; and
the correction is a process in which differences between the representative values of the other image data group and the representative values of the at least one predetermined image data group are added to each of the pixel data of the at least one predetermined image data group, in the case that the pixel data of the at least one predetermined image data group are greater than or equal to the representative value of the at east one predetermined image data group.

9. An apparatus for generating a composite image data set as defined in claim 3, wherein:
the correction is a process in which each of the pixel data of the at least one predetermined image data group are multiplied by the ratios of representative values of the other image data group with respect to the representative values of the at least one predetermined image data group, in the case that the values of the pixel data of the at least one predetermined image data group are less than the representative value of the at least one predetermined image data group; and
the correction is a process in which differences between the representative values of the other image data group and the representative values of the at least one predetermined image data group are added to each of the pixel data of the at least one predetermined image data group, in the case that the pixel data of the at least one predetermined image data group are greater than or equal to the representative value of the at east one predetermined image data group.

10. An apparatus for generating a composite image data set as defined in claim 2, wherein:
the apparatus further comprises a line detecting means constituted by a plurality of line sensors, which are arranged so that the longitudinal directions of each of the line sensors overlap in a main scanning direction;
an image carrier is relatively moved with respect to the line detecting means in a sub scanning direction that intersects with the main scanning direction, so that light emitted from the image carrier is detected by the line detecting means to obtain image data that represents image information carried by the image carrier, while photoreceptors positioned at the overlapping ends of the line sensors detect light emitted from common regions of the image carrier in a duplicate manner; and
the image data groups comprise image data obtained by each of the plurality of line sensors.

11. An apparatus for generating a composite image data set as defined in claim 3, wherein:
the apparatus further comprises a line detecting means constituted by a plurality of line sensors, which are arranged so that the longitudinal directions of each of the line sensors overlap in a main scanning direction;
an image carrier is relatively moved with respect to the line detecting means in a sub scanning direction that intersects with the main scanning direction, so that light emitted from the image carrier is detected by the line detecting means to obtain image data that represents image information carried by the image carrier, while photoreceptors positioned at the overlapping ends of the line sensors detect light emitted from common regions of the image carrier in a duplicate manner; and
the image data groups comprise image data obtained by each of the plurality of line sensors.

12. An apparatus for generating a composite image data set as defined in claim 4, wherein:
the apparatus further comprises a line detecting means constituted by a plurality of line sensors, which are arranged so that the longitudinal directions of each of the line sensors overlap in a main scanning direction;
an image carrier is relatively moved with respect to the line detecting means in a sub scanning direction that intersects with the main scanning direction, so that light emitted from the image carrier is detected by the line detecting means to obtain image data that represents image information carried by the image carrier, while photoreceptors positioned at the overlapping ends of the line sensors detect light emitted from common regions of the image carrier in a duplicate manner; and
the image data groups comprise image data obtained by each of the plurality of line sensors.

13. An apparatus for generating a composite image data set as defined in claim 5, wherein:
the apparatus further comprises a line detecting means constituted by a plurality of line sensors, which are arranged so that the longitudinal directions of each of the line sensors overlap in a main scanning direction;
an image carrier is relatively moved with respect to the line detecting means in a sub scanning direction that intersects with the main scanning direction, so that light emitted from the image carrier is detected by the line detecting means to obtain image data that represents image information carried by the image carrier, while photoreceptors positioned at the overlapping ends of the line sensors detect light emitted from common regions of the image carrier in a duplicate manner; and
the image data groups comprise image data obtained by each of the plurality of line sensors.

14. An apparatus for generating a composite image data set as defined in claim 6, wherein:
the apparatus further comprises a line detecting means constituted by a plurality of line sensors, which are arranged so that the longitudinal directions of each of the line sensors overlap in a main scanning direction;
an image carrier is relatively moved with respect to the line detecting means in a sub scanning direction that intersects with the main scanning direction, so that light emitted from the image carrier is detected by the line detecting means to obtain image data that represents image information carried by the image carrier, while photoreceptors positioned at the overlapping ends of the line sensors detect light emitted from common regions of the image carrier in a duplicate manner; and
the image data groups comprise image data obtained by each of the plurality of line sensors.

15. An apparatus for generating a composite image data set as defined in claim 7, wherein:
the apparatus further comprises a line detecting means constituted by a plurality of line sensors, which are arranged so that the longitudinal directions of each of the line sensors overlap in a main scanning direction;
an image carrier is relatively moved with respect to the line detecting means in a sub scanning direction that intersects with the main scanning direction, so that light emitted from the image carrier is detected by the line detecting means to obtain image data that represents image information carried by the image carrier, while photoreceptors positioned at the overlapping ends of the line sensors detect light emitted from common regions of the image carrier in a duplicate manner; and
the image data groups comprise image data obtained by each of the plurality of line sensors.

16. An apparatus for generating a composite image data set as defined in claim 8, wherein:
the apparatus further comprises a line detecting means constituted by a plurality of line sensors, which are arranged so that the longitudinal directions of each of the line sensors overlap in a main scanning direction;
an image carrier is relatively moved with respect to the line detecting means in a sub scanning direction that intersects with the main scanning direction, so that light emitted from the image carrier is detected by the line detecting means to obtain image data that represents image information carried by the image carrier, while photoreceptors positioned at the overlapping ends of the line sensors detect light emitted from common regions of the image carrier in a duplicate manner; and
the image data groups comprise image data obtained by each of the plurality of line sensors.

17. An apparatus for generating a composite image data set as defined in claim 9, wherein:
the apparatus further comprises a line detecting means constituted by a plurality of line sensors, which are arranged so that the longitudinal directions of each of the line sensors overlap in a main scanning direction;
an image carrier is relatively moved with respect to the line detecting means in a sub scanning direction that intersects with the main scanning direction, so that light emitted from the image carrier is detected by the line detecting means to obtain image data that represents image information carried by the image carrier, while photoreceptors positioned at the overlapping ends of the line sensors detect light emitted from common regions of the image carrier in a duplicate manner; and
the image data groups comprise image data obtained by each of the plurality of line sensors.

18. An apparatus for generating a composite image data set as defined in claim 10, wherein:
the image data groups comprise image data that represents image information of linear regions that extend in the main scanning direction of the image carrier.

19. An apparatus for generating a composite image data set as defined in claim 11, wherein:
the image data groups comprise image data that represents image information of linear regions that extend in the main scanning direction of the image carrier.

20. An apparatus for generating a composite image data set as defined in claim 12, wherein:
the image data groups comprise image data that represents image information of linear regions that extend in the main scanning direction of the image carrier.

21. An apparatus for generating a composite image data set as defined in claim 13, wherein:
the image data groups comprise image data that represents image information of linear regions that extend in the main scanning direction of the image carrier.

22. An apparatus for generating a composite image data set as defined in claim 14, wherein:
the image data groups comprise image data that represents image information of linear regions that extend in the main scanning direction of the image carrier.

23. An apparatus for generating a composite image data set as defined in claim 15, wherein:
the image data groups comprise image data that represents image information of linear regions that extend in the main scanning direction of the image carrier.

24. An apparatus for generating a composite image data set as defined in claim 16, wherein:
the image data groups comprise image data that represents image information of linear regions that extend in the main scanning direction of the image carrier.

25. An apparatus for generating a composite image data set as defined in claim 17, wherein:
the image data groups comprise image data that represents image information of linear regions that extend in the main scanning direction of the image carrier.

26. An apparatus for generating a composite image data set as defined in claim 10, wherein:
the image data groups comprise image data that represents image information of a single row of pixel regions that extend in the main scanning direction of the image carrier.

27. An apparatus for generating a composite image data set as defined in claim 11, wherein:
the image data groups comprise image data that represents image information of a single row of pixel regions that extend in the main scanning direction of the image carrier.

28. An apparatus for generating a composite image data set as defined in claim 12, wherein:
the image data groups comprise image data that represents image information of a single row of pixel regions that extend in the main scanning direction of the image carrier.

29. An apparatus for generating a composite image data set as defined in claim 13, wherein:
the image data groups comprise image data that represents image information of a single row of pixel regions that extend in the main scanning direction of the image carrier.

30. An apparatus for generating a composite image data set as defined in claim 14, wherein:
the image data groups comprise image data that represents image information of a single row of pixel regions that extend in the main scanning direction of the image carrier.

31. An apparatus for generating a composite image data set as defined in claim 15, wherein:
the image data groups comprise image data that represents image information of a single row of pixel regions that extend in the main scanning direction of the image carrier.

32. An apparatus for generating a composite image data set as defined in claim 16, wherein:
the image data groups comprise image data that represents image information of a single row of pixel regions that extend in the main scanning direction of the image carrier.

33. An apparatus for generating a composite image data set as defined in claim 17, wherein:
the image data groups comprise image data that represents image information of a single row of pixel regions that extend in the main scanning direction of the image carrier.
